(19) United States
(12) Patent Application Publication
(10) Pub. No.: US 2023/0074117 A1
(43) Pub. Date: Mar. 9, 2023

(54) METHODS AND SYSTEMS FOR LEARNING ONLINE TO PREDICT TIME-SERIES DATA

(71) Applicants: Applied Brain Research Inc., Waterloo (CA); National Research Council of Canada, Ottawa (CA)

(72) Inventors: Terry Stewart, Ottawa (CA); Andreas Stoeckel, Waterloo (CA); Christopher Eliasmith, Waterloo (CA)

(21) Appl. No.: 17/895,910

(22) Filed: Aug. 25, 2022

Related U.S. Application Data
(60) Provisional application No. 63/237,016, filed on Aug. 25, 2021.

(51) Int. Cl. G06N 3/04; G06N 3/08

(52) U.S. Cl. CPC G06N 3/04; G06N 3/08

(57) ABSTRACT

The present invention relates to methods and systems for learning online to predict time-series data. More specifically, the present invention discloses a system that takes at least one time-varying signal as input, and use a model with an adjustable set of parameters to predict the future values of this time-varying signal as output. The system maintains a compressed representation of the history of its predicted output values, and a learning rule is used to compute an update to the system's parameters so as to reduce any discrepancy between the current value of the time varying signal and all previous predictions for this value that are stored in the compressed representation. The system is operated to perform at least one robotic control, pattern classification, signal processing, or data generation task that is improved by predicting the future values of a time-varying input signal.

### (1) FIELD OF THE INVENTION

The present invention generally relates to the fields of artificial intelligence and robotics. More specifically, the present invention relates to the use of a computational model to learn to predict the future values of a time-varying signal directly from past values of this signal in an “online” or real-time manner, wherein the network continuously updates its parameters in response to changes in the input signal to produce improved predictions.

### (2) BACKGROUND OF THE INVENTION

Given any numerical value that changes over time, it is often useful to be able to predict what that value will be in the near future. To give one example, when controlling a robotic arm, it is useful to know how the arm will continue to move in the near future due to momentum and gravity. Such knowledge can allow one to more effectively control the arm to reach or grasp an object of interest. To give another example, when tracking the location of a person in a video stream, it is useful to know where the person will move next on the basis of their goals and surrounding context. Such knowledge can allow one to more effectively warn or engage the individual if their behavior is likely to lead them to harm (e.g., they are walking into the path of an oncoming vehicle). A common technique for building machine learning systems that make these kinds of time-series predictions involves the use of recurrent neural network algorithms (RNNs) that repeatedly apply a fixed set of connection weights to a state vector so as to produce an output prediction in response to each processed input value.

Example applications of RNNs for time-series prediction span a variety of fields, including automatic speech recognition, natural language processing, bio-signal classification, and supply chain optimization. For most of these applications, training an RNN involves gathering historical time-series data and then optimizing the network's parameters to generate accurate predictions with this historical data. Numerous efforts have been made to demonstrate and enhance the effectiveness of RNNs for time-series prediction, leading to a number of novel neural network systems being defined in the prior art. Given as much, the following documents and patents are provided for their supportive teachings and are all incorporated by reference: “Voelker et al. (Legendre Voelker, Aaron R. et al. “Legendre Memory Units: Continuous-Time Representation in Recurrent Neural Networks,” NeurIPS (2019) discloses a method for optimally compressing a time-series of input values into the state vector of a recurrent neural network, thereby allowing the network to make accurate predictions with much longer input sequences than it would otherwise be able to handle. Importantly, the predictions that are made using this method can involve generating either a single classification label or entire output time series in response to a single input time series.

Another prior art document, Salinas et al. (David Salinas, Valentin Flunkert, Jan Gasthaus, Tim Januschowski, DeepAR: Probabilistic forecasting with autoregressive recurrent networks, International Journal of Forecasting, Volume 36, Issue 3, 2020, Pages 1181-1191), describes methods for training long short-term memory (LSTM) RNNs for time series forecasting by a learning global prediction model from related time series’. These methods are robust to variable input scales and are able to produce probabilistic forecasting predictions that are highly accurate. Interestingly, the methods have been applied to supply and demand forecasting prediction problems in the field of supply chain optimization, and have been shown to be able to handle seasonal patterns in time-series data and learn on relatively small datasets of a few hundred time-series.

A further prior art document, Syama et al. (Rangapuram, Syama Sundar et al. “Deep State Space Models for Time Series Forecasting.” NeurIPS (2018)) describes a method for performing probabilistic time series forecasting via a combination of state space modeling and deep learning. The advantages of this method are that it preserves certain desirable features of state space models (namely data efficiency and interpretability), while also leveraging the ability of deep learning systems to learn complicated statistical patterns from large amounts of data. The method offers very good performance on a range of time-series prediction tasks, and has been shown to outperform other RNN-based methods, methods based on matrix factorization, and more traditional methods that rely on moving averages of past input values to make predictions.

Notably, all of the methods and systems described in the aforementioned references and many similar references require fitting a model to previously collected data prior to making any prediction on novel time-series inputs. In other words, the model is first trained and then deployed, at which point no further updates to the model's parameters take place. Implicit in this approach is the assumption that the underlying distribution of the data encountered during deployment is the same or similar to the underlying distribution of the historical data that was used for training. In many cases, this assumption proves false, resulting in degraded prediction performance. Additionally, by not learning after deployment, the methods described in the prior art are inherently inefficient in that they do exploit any of the data encountered during the deployment period to improve performance. In some application contexts, the amount of data encountered during deployment may be orders of magnitude greater than the amount of data used for training.

The present application addresses the above-mentioned concerns and shortcomings by defining methods and systems for learning online to predict time-series data. More specifically, we introduce methods and systems that enable a time-series prediction system to improve its predictions using new input data it is presented with. Learning “online” from newly presented input data in this manner would, under a naive approach, require storing a large amount of data in the form of pairings between each input value and the set of successor values that should be predicted from this input value. To avoid explicitly storing all of this data during system deployment (which is impractical), we introduce a mechanism for compressing the data on the fly in a way that enables a learning rule to operate directly on this compressed data, producing a time-series prediction system that can efficiently learn online after it has been deployed.

### (3) SUMMARY OF THE INVENTION

In the view of the foregoing limitations inherent in the known methods for time series forecasting, the present invention provides methods and systems for predicting the future values of a time-varying input signal in an online manner. The main component of the invention is a prediction model in the form of an artificial neural network which takes as its input the current value of the time-varying signal. The output of this model is a prediction of the future values of the time-varying signal over some continuous window. Rather than predict these future values directly, however, the prediction model produces a vector of coefficients that represent the future values in terms of a set of basis functions. Typically, the Legendre polynomials are used as a basis, but other options (e.g. the Fourier series) are also appropriate. Finally, a learning rule is used to compare the current value of the input signal to all past predictions for this value that are stored in the basis representation of the prediction window. By updating the parameters of the prediction model on the basis of this learning rule's comparison between the present input value and past predictions of this input value, the present invention yields a system that is able to continuously improve its predictions of the future values of an input signal over time. As such, the general purpose of the present invention, which will be described subsequently in greater detail, is to provide methods and systems that enable continuous, online learning of the parameters of models that predict future values of an input signal using past values of this signal.

The main aspect of the present invention is to define methods and systems for learning online to predict time series data. The methods consist of defining an artificial neural network model that takes at least one time-varying signal as input, and uses a set of adjustable model parameters to compute and produce as output a set of network activity values and a set of predicted future values of the at least one time-varying signal. The methods further consist of defining a memory model that creates a compressed representation of these predicted future values, and defining a learning rule that compares the present input value to past predictions of this value that are stored in the aforementioned compressed representation; the output of the learning rule is a set of updates to the parameters of the artificial neural network model that improve its performance. Finally, the methods further comprise operating the artificial neural network model, the memory model, and the learning rule to predict future values of the at least one time-varying signal for the purpose of performing at least one control, object tracking, classification, signal processing, or data generation task.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty which characterize the invention, are pointed out with particularity in the disclosure. For a better understanding of the invention, its operating advantages and the specific objects attained by its uses, reference should be had to the accompanying drawings and descriptive matter in which there are illustrated preferred embodiments of the invention.

### (4) BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a block diagram of the overall system for learning online to predict time-series data.

FIGS. 2A to 2D are depictions of how the memory model compresses data as a linear combination of basis functions.

FIGS. 3A to 3D are depictions of the outputs of the system as it is used to learn to predict the future values of a continuous input signal.

FIG. 4 is a block diagram of an illustrative embodiment of the system being used to learn to control a robotic device.

FIGS. 5A to 5D are depictions of the outputs of the system as it used in the illustrative embodiment in FIG. 4.

### (5) DETAILED DESCRIPTION OF THE INVENTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that the embodiments may be combined, or that other embodiments may be utilized and that structural and logical changes may be made without departing from the spirit and scope of the present invention. The following detailed description is, therefore, not to be taken in a limiting sense, and the scope of the present invention is defined by the appended claims and their equivalents.

The present invention is described in brief with reference to the accompanying drawings. Now, refer in more detail to the exemplary drawings for the purposes of illustrating non-limiting embodiments of the present invention.

As used herein, the term “comprising” and its derivatives including “comprises” and “comprise” include each of the stated integers or elements but does not exclude the inclusion of one or more further integers or elements.

As used herein, the singular forms “a”, “an”, and “the” include plural referents unless the context clearly dictates otherwise. For example, reference to “a device” encompasses a single device as well as two or more devices, and the like.

As used herein, the terms “for example”, “like”, “such as”, or “including” are meant to introduce examples that further clarify more general subject matter. Unless otherwise specified, these examples are provided only as an aid for understanding the applications illustrated in the present disclosure, and are not meant to be limiting in any fashion.

As used herein, the terms “may”, “can”, “could”, or “might” be included or have a characteristic, that particular component or feature is not required to be included or have the characteristic.

Exemplary embodiments will now be described more fully hereinafter with reference to the accompanying drawings, in which exemplary embodiments are shown. These exemplary embodiments are provided only for illustrative purposes and so that this disclosure will be thorough and complete and will fully convey the scope of the invention to those of ordinary skill in the art. The invention disclosed may, however, be embodied in many different forms and should not be construed as limited to the embodiments set forth herein.

Various modifications will be readily apparent to persons skilled in the art. The general principles defined herein may be applied to other embodiments and applications without departing from the spirit and scope of the invention. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure). Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For clarity, details relating to technical material that is known in the technical fields related to the invention have not been described in detail so as not to unnecessarily obscure the present invention.

Thus, for example, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named element.

Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims.

All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Various terms as used herein are shown below. To the extent a term used in a claim is not defined below, it should be given the broadest definition persons in the pertinent art have given that term as reflected in printed publications and issued patents at the time of filing.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all groups used in the appended claims.

For simplicity and clarity of illustration, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments generally described herein.

Furthermore, this description is not to be considered as limiting the scope of the embodiments described herein in any way, but rather as merely describing the implementation of various embodiments as described.

The described systems can be implemented using adaptive or non-adaptive components. The system can be efficiently implemented on a wide variety of distributed systems that include a large number of non-linear components whose individual outputs can be combined together to implement certain aspects of the system as will be described more fully herein below.

As used herein the term ‘node’ in the context of an artificial neural network refers to a basic processing element that implements the functionality of a simulated ‘neuron’, which may be a spiking neuron, a continuous rate neuron, or an arbitrary linear or non-linear component used to make up a distributed system.

As used herein the term ‘artificial neural network’ (ANN) refers to a collection of two or more neurons coupled together via weighted connections such that inputs to the network can generate activation values in one or more of the neurons, which in turn produce network outputs. The term ‘inputs’ refers to any analog or digital signal that is used to drive activity in a neural network; inputs can be user-supplied, derived from sensors spanning arbitrary modalities, or drawn from arbitrary pre-existing datasets.

The embodiments of the artificial neural networks described herein may be implemented in configurable hardware (i.e., an FPGA) or custom hardware (i.e., an ASIC), or a combination of both with at least one interface. The input signal is consumed by the digital circuits to perform the functions described herein and to generate the output signal. The output signal is provided to one or more adjacent or surrounding systems or devices in a known fashion.

The main embodiment of the present invention is a set of systems and methods for learning online to predict time series data. The methods consist of defining a artificial neural network model that takes the at least one time-varying signal as input, and uses a set of adjustable model parameters to compute and produce as output a set of network activity values and a set of predicted future values of the at least one time-varying signal. The methods further consist of defining a memory model that creates a compressed representation of these predicted future values, and defining a learning rule that compares the present input value to past predictions of this value that are stored in the aforementioned compressed representation; the output of the learning rule is a set of updates to the parameters of the artificial neural network model that improve its performance. Finally, the methods further comprise operating the artificial neural network model, the memory model, and the learning rule to predict future values of the at least one time-varying signal for the purpose of performing at least one control, classification, signal processing, or data generation task.

The term ‘prediction model’ here refers to any method or algorithm for applying transformations to one or more input values to make predictions on the basis of these input values. An example of a prediction model is an artificial neural network that transforms its input values into predicted output values by propagating activities through the network via connection weights that link neurons to one another. The connection weights in an artificial neural network may be recurrent, feedforward, or convolutional.

The term ‘memory model’ here refers to any method or algorithm that transforms a continuous window of signal values into a vector of coefficients that provides a weighting over a set of basis functions that can subsequently be used to reconstruct the original signal values. In the exemplary embodiments disclosed below, the Legendre polynomials are used as basis functions, but other options (e.g. the Fourier or Cosine series) are also possible.

The term ‘learning rule’ here refers to any method or algorithm that compares the outputs of a prediction model to a set of target values, and then computes an update to the parameters of the prediction model to minimize the difference between the outputs and the target values. The comparison a learning rule performs between predicted outputs and target values produces a scalar value called a ‘loss metric’, and the updates the learning rule applies to the prediction model's parameters function to reduce this metric (a value of 0 for a loss metric typically means that a prediction model has perfect prediction accuracy). Examples of loss metrics include mean-squared error (MSE), cross-entropy loss (categorical or binary), Kullback-Leibler divergence, cosine similarity, and hinge loss.

The nonlinear components of the aforementioned systems can be implemented using a combination of adaptive and non-adaptive components. Examples of nonlinear components that can be used in various embodiments described herein include simulated/artificial neurons, FPGAs, GPUs, and other parallel computing systems. Components of the system may be implemented using a variety of standard techniques such as by using microcontrollers. In addition, non-linear components may be implemented in various forms including software simulations, hardware, or any neuronal fabric. Non-linear components may also be implemented using neuromorphic computing devices such as Neurogrid, SpiNNaker, Loihi, and TrueNorth.

In what follows, illustrative embodiments of the proposed systems and methods are disclosed in detail. These illustrative embodiments are methods and systems that generally provide for prediction of the future values of a measured input value over some window into the future, and continual updating of that prediction as new data arises. The prediction is done using artificial neurons that implement a neural network. Improvement of the prediction is performed by three separate modules: the first module is a memory that stores the past history of the network's internal states, the second module is a memory stores the past history of the network's predictions, and the third module implements a learning rule that combines this past history information with the currently observed signal to determine how to adjust the parameters of artificial neural network.

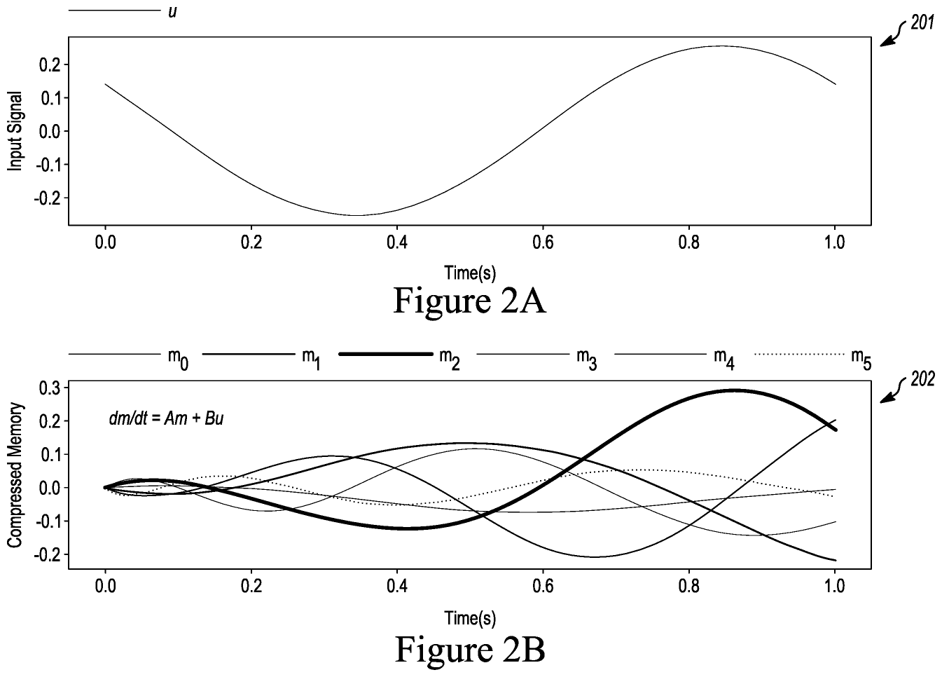

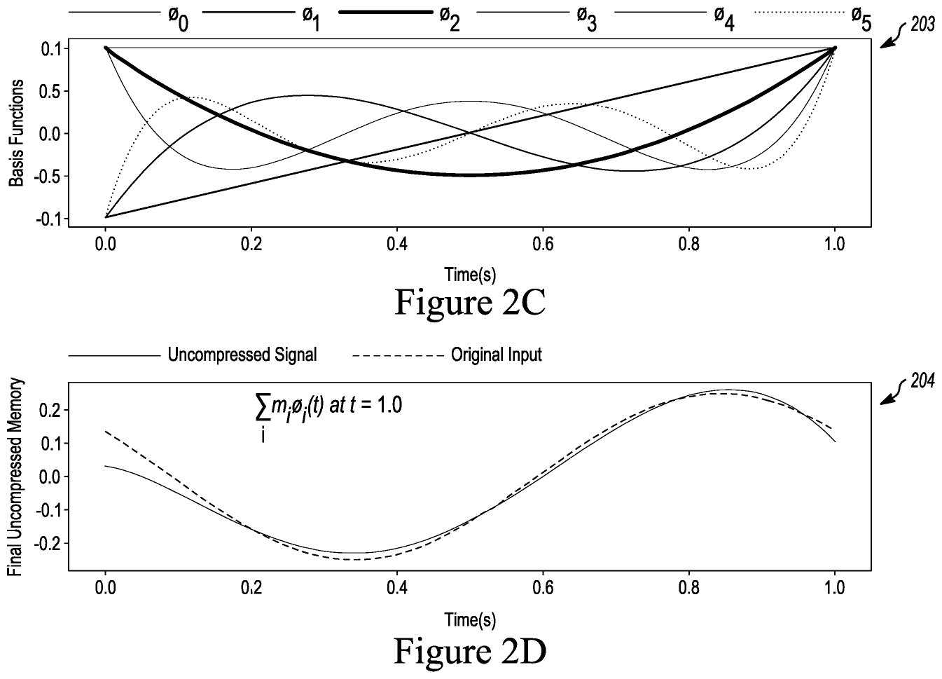

In the first example embodiment presented herein, the artificial neural network consists of non-spiking neurons, although spiking neurons may also be used. The network takes as input any currently available context information that can be used to make the prediction. This normally includes the current value of the signal to be predicted, although it does not have to. Any other information may also be included (for example, if the system is meant to predict future stock values, the context could include the current stock value, plus the current value of other stocks, the past values of the current stock, other economic indicators, or even weather information). In the example embodiment presented herein, referring to FIGS. 2A to 2D, the output of the neural network (the predictions of the future values of the input) [201] are encoded as the coefficients [202] in the Legendre polynomial basis space [203]. That is, rather than having one output for each time point in the future (e.g. one output for the prediction 1 ms into the future, another output for 2 ms into the future, another for 3 ms into the future, and so on up to some limit), the output is z, a q-dimensional vector. The prediction for any point in time t [204] in the future can be computed as Σᵢ zᵢϕᵢ(t) where ϕᵢ is the ith basis function. While Legendre polynomials are used for this example embodiment, any other basis space could also be used (e.g. Fourier, Cosine, etc.).

In the first example embodiment presented herein, two memory systems store data using a basis space rather than storing the raw data. In particular, this example embodiment uses Legendre polynomials, although other bases may also be used. Furthermore, these memories must be updated continuously (i.e., they always store the information over some window of time in the past). In the simplest implementation (i.e., just storing the raw data without Legendre polynomials) this would be implemented as a ring buffer (a fixed amount of data storage where one repeatedly deletes the oldest value and replaces it with the newest value). When using a basis space implementation, much less data storage is needed, but more computation is needed to update the stored data. In the example embodiment presented herein, the memory systems use the Legendre polynomial basis space for storage. In Voelker et al., an efficient linear algorithm is derived to compute this update, of the form

$$\frac{d m}{dt} = Am + Bu$$

where m is the q-dimensional memory vector (the Legendre coefficients), A and B are constants, and u is the value to be stored (e.g., the neural activity to be stored in the first memory module, or the predictions to be stored in the second memory module). This calculation can be instantiated using traditional digital computers, or could be instantiated in any physical system capable of implementing or approximating a linear differential equation.

In the first example embodiment presented herein, a learning module combines the memory of the past activity values, the memory of the past predictions, and the currently observed value to produce a desired adjustment to the neural network's parameters in order to improve its predictions. Any standard neural network learning rule can be used, but in the example embodiment presented herein the simplest learning rule is used: the Delta rule. In this rule, the calculation required is to multiply the activity of the network at the time the prediction was made by the difference between the prediction and the observed value. That is, whenever a new observed value is input into the system, the weights are updated based on the prediction that was made 1 ms ago about what would happen 1 ms into the future, the prediction that was made 2 ms ago about what would happen 2 ms into the future, the prediction that was made 3 ms ago about what would happen 3 ms into the future, and so on up to the amount of time into the future that predictions are being made.

To implement the above learning rule efficiently, the example embodiment combines all of those calculations into a single matrix operation. Any memory system based on basis functions allows for a linear operation to extract the particular past predictions or past neural activities. Because these operations are linear, the effect of the complete iterated learning rule described in the previous paragraph can be rewritten as Δω= [symbol] N(MQ_{M}−sQ_{S}) where N is the compressed basis space representation of the past activity of the network, M is the compressed basis space representation of the past predictions of the network, s is the currently observed value that is to be predicted, and Q_{M} and Q_{S} are constants that depend on the basis spaces used from the two memories and the prediction. For the special case of all three basis spaces being Legendre polynomials, Q_{S} is the identity matrix.

In the first example embodiment presented herein, this efficient learning rule Δω= [symbol] N(MQ_{M}−sI) is implemented using traditional digital computers optimized for matrix multiplication. It could also be implemented in any other physical hardware capable of computing a linear transformation and applying the resulting value as a change in the neural network connection weights. The resulting system is then run autonomously, and will then gradually adjust its output to be a prediction of the future values of its input over some window in time into the future. The neural network inside the system can be initialized randomly, or with zero weights, or using any offline training system such as traditional back-propagation learning. Once deployed, it uses the internal learning rule to gradually adjust its weights, improving its prediction based on its observed input values.

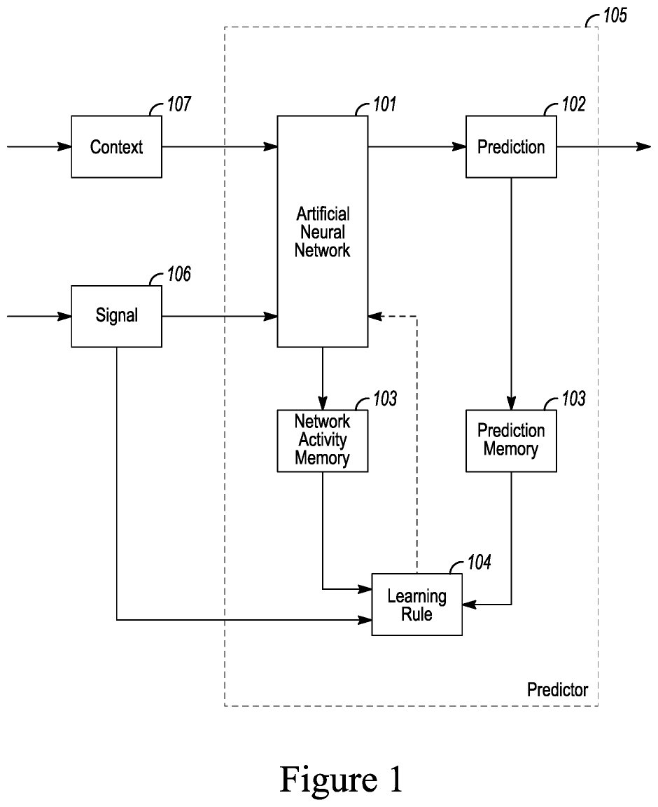

Based on the methods just disclosed, a working example of the proposed invention is described below and depicted in FIG. 1:

A single-hidden-layer neural network [101] with two inputs, 100 hidden-layer neurons, and six outputs. The input connection weights are initialized randomly and the output connection weights are initialized to zero. The neurons are rectified linear neurons.

A memory module [103] to store the activity of the neurons over the last 100 ms. This has 100 inputs and stores the matrix N which is a 100×6 matrix. The memory is updated as per

$$\frac{{dN}_{i}}{dt} = {AN}_{i} + {Bn}_{i}$$

where A and B are the fixed matrices from Voelker et al. that use the Legendre polynomial basis space and nᵢ is the output of the ith neuron.

A memory module [103] to store the output predictions [102] over the last 100 ms. This has 6 inputs and stores the matrix M which is a 6×6 matrix. The memory is updated as per

$$\frac{d {m}_{i}}{dt} = {Am}_{i} + {Bz}_{i}$$

where A and B are the fixed matrices from Voelker et al., that use the Legendre polynomial basis space and zᵢ is the zth output of from the network.

A learning module [104] that computes Δω= [symbol] N(MQ_{M}−sI) and adjusts the weights co in the network accordingly.

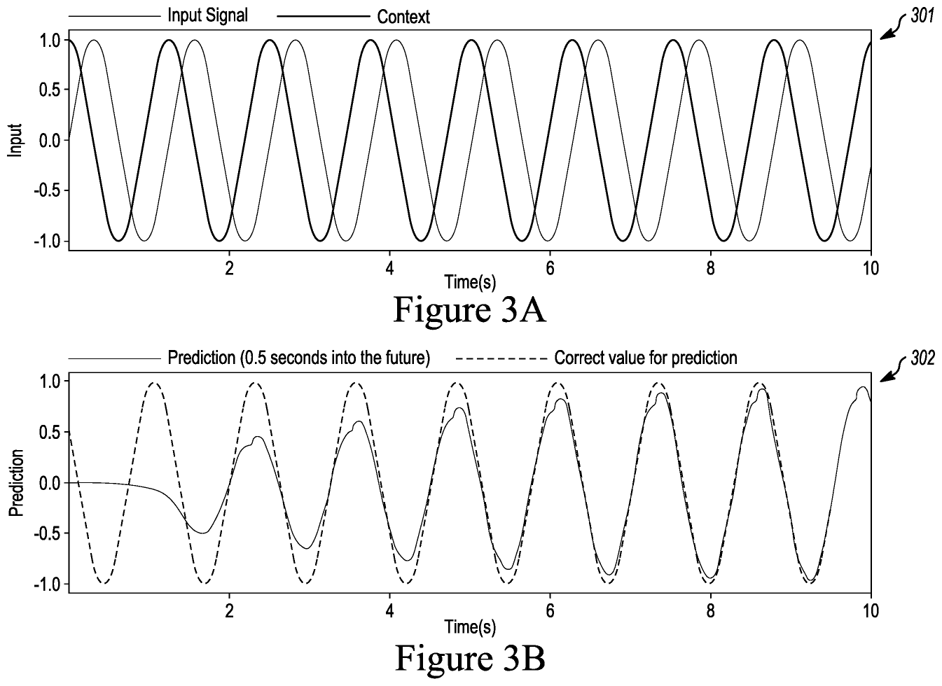

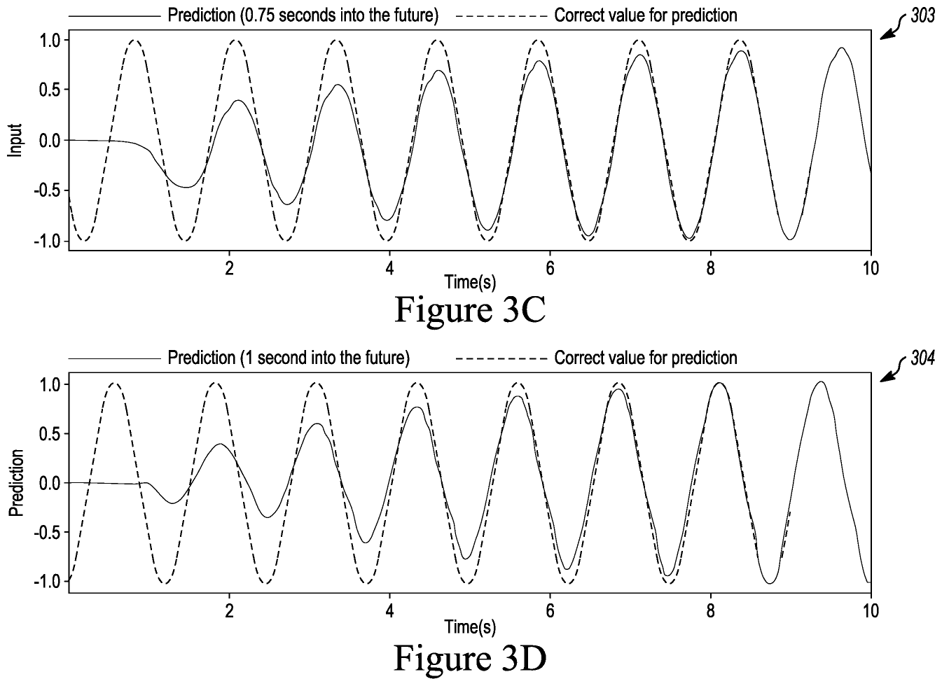

Each of these components is implemented in a digital computer and a new observed value is input every 1 ms. The inputs (i.e. the context) are the current value of the signal [106] to be predicted and its derivative [107]. The system [105] described here can be used as a component within a larger system where that larger system uses the predictions to perform some task. The resulting behavior of this working example for a random bandwidth-limited input signal is given in FIGS. 3A to 3D, with the input signal [301] being shown along with learned predictions of this signal 0.5 [302], 0.75 [303], and 1 [304] seconds into the future.

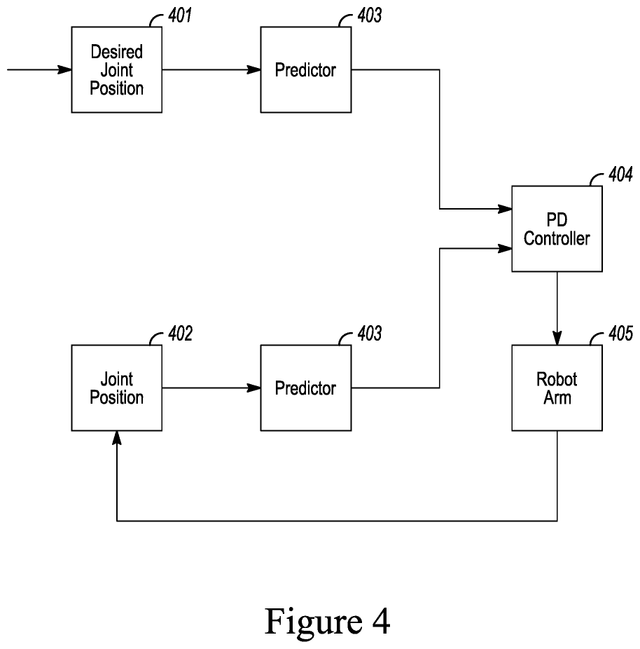

In the second example embodiment presented herein and depicted in FIG. 4, the proposed invention is incorporated into a motor control system for controlling a robotic arm [405]. In traditional proportional motor control, the signal sent to a motor is based on the difference between the desired position [401] of a motor and its current position [402]. If the prediction system [403] described here is included, then the motor control can be based on the difference between the desired position of the motor and its predicted position at some fixed time into the future. In practice, this resulting system allows the control to occur even in the presence of significant motor control delays (which generally disrupt the performance of non-predictive PD controllers).

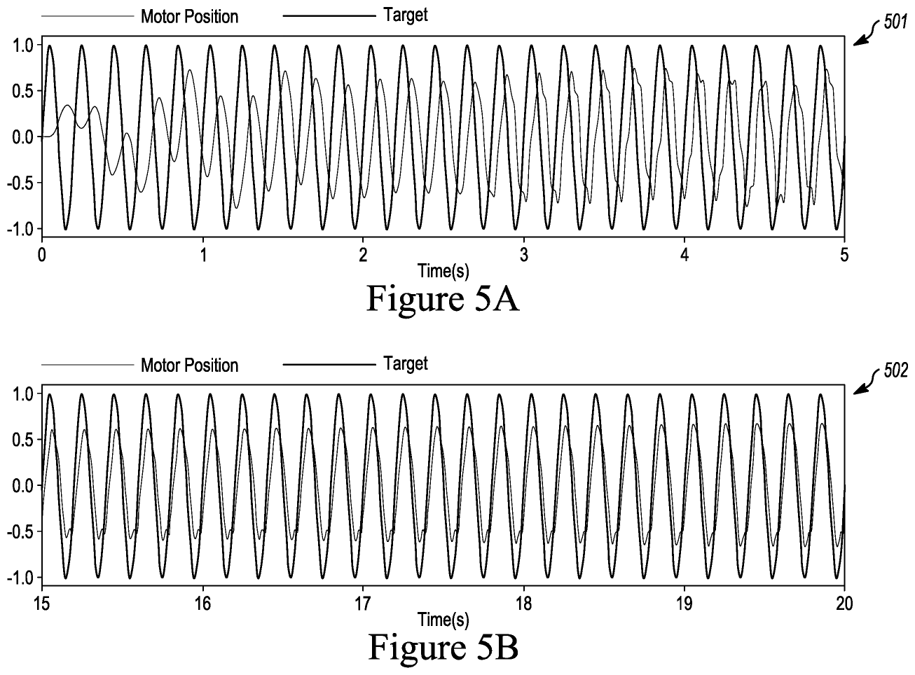

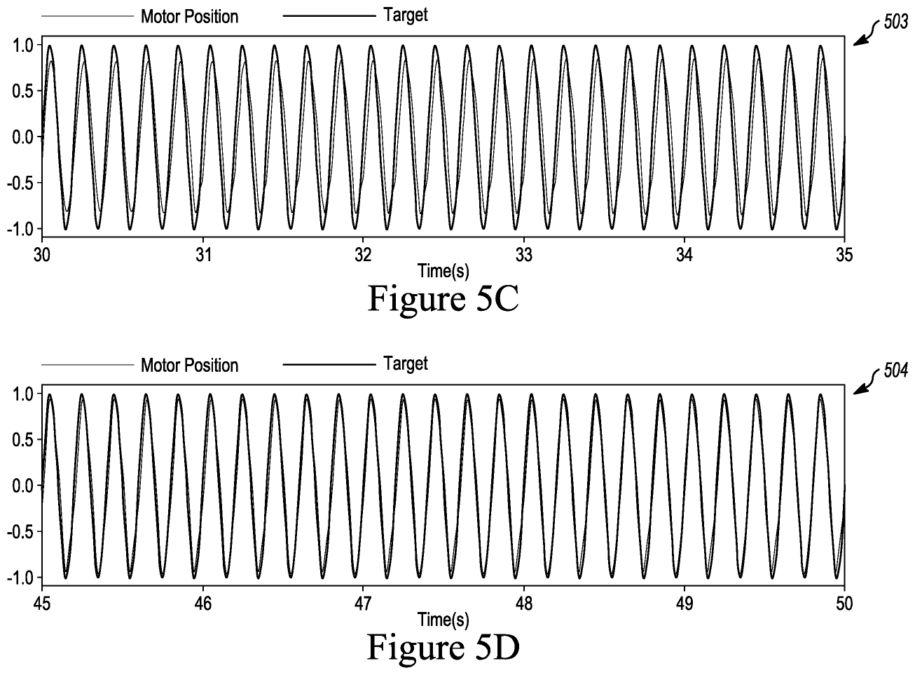

The above proportional motor control system is here extended to proportional-derivative (PD) control [404] by noting that since the predictions are made using a basis space, the prediction of the future value also automatically includes a prediction of the derivative of the future value, and so this can be used in the same manner as the predicted value in the proportional control case above. Referring to FIGS. 5A to 5D, the outputs for this exemplary embodiments are shown over time, with the initially generated control positions [501] progressively converging on the target control positions [502, 503, 504] as result of exploiting the predicted future values of these positions.

As a further extension of the PD motor control system, a separate prediction system can be used to predict the future of the desired position of the motor. That is instead of taking the difference between the current position and the current desired position, the controller would take the difference between the predicted position at some point in the future and the predicted desired position at that same point in the future. This will compensate for any delays in the control system, if the prediction is accurate. Furthermore, rather than picking one time point in the future, a weighted sum over a window of time may be taken.

It is to be understood that the above description is intended to be illustrative, and not restrictive. For example, the above-discussed embodiments may be used in combination with each other. Many other embodiments will be apparent to those of skill in the art upon reviewing the above description.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the embodiments.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention.

1. A computer implemented method for predicting the future values of at least one time-varying signal, comprising:
a. defining an artificial neural network model that takes the at least one time-varying signal as input, and uses a set of adjustable parameters to produce as output at each time t:
i. a set of network activities corresponding to the state of the artificial neural network model at t;
ii. a set of predicted future values of the at least one time-varying signal;
b. defining a memory model that takes a set of network activities and a set of predicted future signal values as input, and produces compressed representations of the history of each of these values over time as output, where said compressed representations are vectors of coefficients over a set of orthogonal basis functions;
c. defining a learning rule that takes said compressed representations and the current value of the at least one time-varying signal as input, and produces as output an update to the artificial neural network model's adjustable parameters that reduces discrepancy between the current value of the at least one time-varying signal and prior predictions of said current value;
and,
d. predicting future values of the at least one time-varying signal based on the learning rule for the purpose of performing at least one of robotic control, pattern classification, object tracking, signal processing and data generation task.

2. The method of claim 1, wherein the inputs to the artificial neural network model include a context signal.

3. The method of claim 1, wherein the memory model is implemented as a linear time invariant dynamical system that projects the inputs to the memory model onto a set of orthogonal basis functions.

4. The method of claim 1, wherein the learning rule is implemented as the Delta Rule.

5. A system for robotic control, pattern classification, object tracking, signal processing, or data generation, the system comprising:
a. at least one artificial neural network model that takes at least one time-varying signal as input, and uses a set of adjustable parameters to produce as output at each time t:
i. a set of network activities corresponding to the state of the at least one artificial neural network model at t;
ii. a set of predicted future values of the at least one time-varying signal;
b. at least one memory model that takes a set of network activities and a set of predicted future signal values as input, and produces compressed representations of the history of each of these values over time as output, where said compressed representations are vectors of coefficients over a set of orthogonal basis functions; and
c. at least one learning rule that takes said compressed representations and the current value of the at least one time-varying signal as input, and produces as output an update to the at least one artificial neural network model's adjustable parameters that reduces any discrepancy between the current value of the at least one time-varying signal and prior predictions of said current value;
wherein the system operates the artificial neural network model, the memory model, and the learning rule to learn to predict future values of the at least one time-varying signal.
